(19) United States
(12) Patent Application Publication
(10) Pub. No.: US 2019/0132717 A1
(43) Pub. Date: May 2, 2019

(54) Enhancing Communication Services

(71) Applicant: Nokia Solutions and Networks Oy, Espoo (FI)

(72) Inventors: Xiang XU, Jiangsu (CN); David NAVRATIL, Helsinki (FI); Hai Tao LI, Beijing (CN)

(21) Appl. No.: 16/096,002

(22) PCT Filed: May 9, 2016
(86) PCT No.: PCT/CN2016/081413

§ 371 Date: Oct. 24, 2018

(51) Int. Cl. H04W 4/44; H04W 76/18; H04W 76/11; H04W 88/10; H04W 8/08; H04W 72/04; H04W 36/08

(52) U.S. Cl. CPC H04W 4/44; H04W 76/18; H04W 76/11; H04L 5/001; H04W 8/08; H04W 72/048; H04W 36/08; H04W 88/10

(57) ABSTRACT

There is provided a method for acquiring, by a first network element of a radio communication system, a radio bearer setup message from a second network element of the radio communication system, the radio bearer setup message indicating at least one radio bearer to be used by a terminal device of the radio communication system for at least one communication service; determining, based on the radio bearer setup message, whether the at least one radio bearer is for a vehicle-related communication service or for some other communication service; and as a response to determining that the at least one radio bearer is for the vehicle-related communication service, configuring the terminal device with at least one cell configured to provide radio resources for the vehicle-related communication service.

### BACKGROUND

Vehicular communication is constantly becoming more popular. This creates increasing performance pressures for present and future communication networks. Therefore, it may be beneficial for the performance of the communication networks to provide solutions that enhance vehicle-related communications.

### BRIEF DESCRIPTION

According to an aspect, there is provided the subject matter of the independent claims. Some embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following embodiments will be described in greater detail with reference to the attached drawings, in which

FIGS. 1A to 1B illustrate example radio communication systems to which embodiments of the invention may be applied;

FIGS. 2 to 4 illustrate flow diagrams according to some embodiments;

FIGS. 5A to 6B illustrate signal diagrams according to some embodiments; and

FIGS. 7 to 9 illustrate apparatuses according to some embodiments.

### DETAILED DESCRIPTION OF SOME EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio communication system, such as in at least one of the following: Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced (LTE-A), and/or LTE-Advanced Pro.

The embodiments are not, however, restricted to the system given as an example but a person skilled in the art may apply the solution to other communication systems provided with necessary properties. Another example of a suitable communications system is the 5G concept. 5G is likely to use multiple input—multiple output (MIMO) techniques (including MIMO antennas), many more base stations or nodes than the LTE (a so-called small cell concept), including macro sites operating in co-operation with smaller stations and perhaps also employing a variety of radio technologies for better coverage and is enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and SG radio interface access comes from small cells by aggregation to the LTE. In other words, SG is planned to support both inter-RAT operability (such as LTE-SG) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility. It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or cloud data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent. Some other technology advancements probably to be used are Software-Defined Networking (SDN), Big Data, and all-IP, which may change the way networks are being constructed and managed.

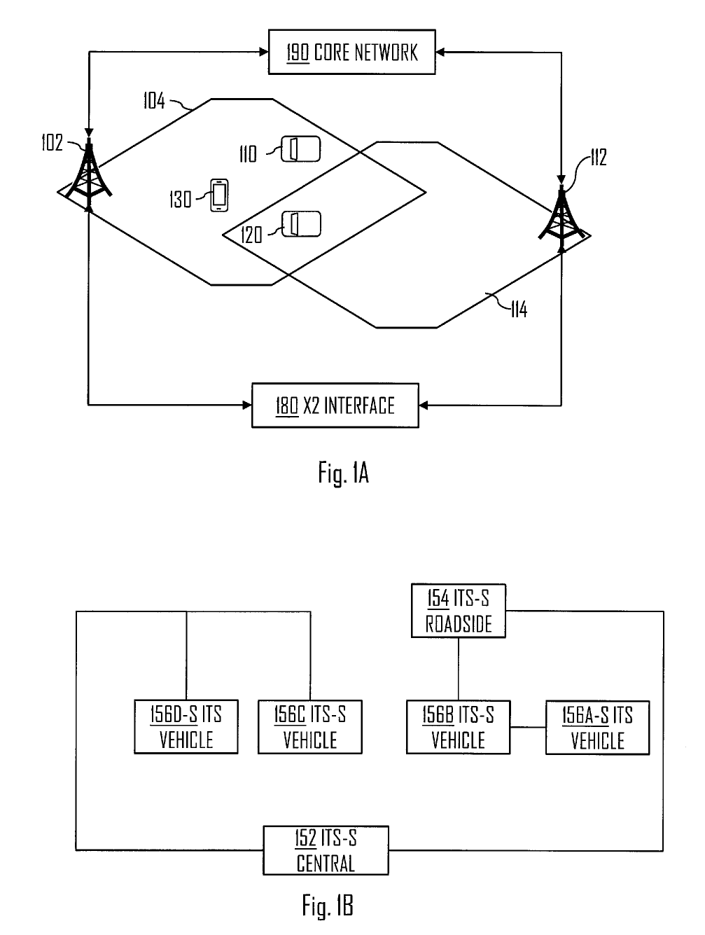

FIG. 1A illustrates an example of a radio communication system to which some embodiments may be applied. The radio communication system may also be referred to as a cellular communication system. Cellular communication networks, such as the Long Term Evolution (LTE), the LTE-Advanced (LTE-A), the LTE-Advanced Pro of the 3rd Generation Partnership Project (3GPP), or the predicted future 5G solutions, are typically composed of at least one network element, such as a network element 102, providing a cell 104. The cell 104 may be, e.g., a macro cell, a micro cell, femto, or a pico-cell, for example. The network element 102 may be an evolved Node B (eNB) as in the LTE and LTE-A, a radio network controller (RNC) as in the UMTS, a base station controller (BSC) as in the GSM/GERAN, or any other apparatus capable of controlling radio communication and managing radio resources within the cell 104. For 5G solutions, the implementation may be similar to LTE-A, for example. The network element 102 may be referred to as a base station or an access node, for example. Also, it is possible that the network element 102 provides more than one cell. Therefore, network element(s) of the radio communication system may each provide one or more cells for providing radio resources to terminal devices 110, 120, 130. Terminal device(s) may also be referred to as User Equipment (UE).

The radio communication system may be composed of a radio access network of network nodes or elements similar to the network element 102, each network node or element controlling a respective cell or cells. For example, the radio communication system may comprise a plurality of network elements providing cells and service for a certain area. The network elements may be connected to each other such that data transfer between the network elements is possible. For example, X2-interface 180 between eNBs may be utilized, but other solutions may also be possible (e.g. wireless data transfer). In the example of FIG. 1A, the X2-interface 180 is used to communicatively couple the network elements 102 and 112 to each other. If there are more similar network elements in the radio communication system, they may also be connected to each other via the X2-interface. In some embodiments, the network element 112 may be similar as the network element 102. In some embodiments, the network element 112 may be controlled by the network element 102. For example, the network element 102 may be a master network element 102 (e.g. MeNB), whereas the network element 112 may be a secondary network element 112 (e.g. SeNB) controlled by the master network element 102.

The network element 102, as any other network elements of the system (e.g. the network element 112), may be connected via a core network interface to a core network 190 of the cellular communication system. In an embodiment, the core network 190 may be called Evolved Packet Core (EPC) according to the LTE terminology. The core network 190 may comprise a mobility management entity (MME), Home Subscriber Server (HSS), Application

Server (AS) and a data routing network element. In the context of the LTE, the MME may track mobility of terminal devices 110, 120, and carries out establishment of bearer services between the terminal devices 110, 120 and the core network 190. In the context of the LTE, the data routing network element may be called a System Architecture Evolution Gateway (SAE-GW). It may be configured to carry out packet routing to/from the terminal devices 110, 120 from/to other parts of the cellular communication system and to other systems or networks, e.g. the Internet.

One aspect of the radio communication system presented in FIG. 1A is the system capability to provide vehicle-related (V2X) communication services. In general, cellular communication may be understood as a way to provide network access to terminal devices, such as mobile phones, tables, and computers. V2X communication may be a part of the cellular communication or it may also be understood as another part of the radio communication. That is in some embodiments, radio communication as presented in this description may be understood as comprising both cellular communication as well as V2X communication. However, a skilled person will understand that V2X communication may also be a part of cellular communication (i.e. V2X terminal devices may be similar as normal terminal devices, such as mobile phones). One aspect of V2X communication systems are Intelligent Transport Systems (ITS). FIG. 1B illustrates an example of ITS system. As explained above, the ITS system may be comprised in the radio communication system of FIG. 1A, for example. ITS are systems to support transportation of goods and humans with information and communication technologies in order to efficiently and safely use the transport infrastructure and transport means (e.g. cars, trains, planes, ships). ITS applications may be distributed among multiple ITS-Stations (ITS-S) in order to share information using wireless communications (e.g. radio communication system). ITS applications may provide a large diversity of communication services. Referring to the example of FIG. 1B, there may be four ITS-S types.

Firstly, a central ITS-S 152 may provide centralized ITS applications. A central ITS-S 152 may play the role of traffic operator, road operator, services provider, or content provider, for example. The central ITS-S 152 may require further connection with backend systems via e.g. Internet, for example. For deployment and performances needs, specific instances of central ITS-S 152 may contain grouping of Applications or Facilities.

Secondly, a road side ITS-S 154 may provide ITS applications from the road side (e.g. situated close to a road or a lane). A road side ITS-S 154 may provide ITS applications independently or cooperatively with central ITS-S or other road side ITS-Ss. For deployment and performances needs, specific instances of road side ITS-S may contain grouping of Applications or Facilities.

Thirdly, a vehicle ITS-S 156 may provide ITS applications to vehicle drivers and/or passengers (e.g. situated in a vehicle). It may require an interface for accessing in-vehicle data from the in-vehicle network or in vehicle system. For deployment and performances needs, specific instances of vehicle ITS-S may contain grouping of Applications or Facilities.

Fourthly, a personal ITS-S may provide ITS applications to personal and nomadic devices, such as mobile phones or tablets. For deployment and performances needs, specific instances of personal ITS-S may contain grouping of Applications or Facilities.

At this point, referring to FIGS. 1A and 1B, it may be necessary to discuss a bit about different terminal devices 110, 120, 130. The terminal devices 110, 120, 130 may comprise mobile phones, smart phones, tablet computers, laptops and other devices used for user communication with the radio communication network. These devices may also act as personal ITS-S devices, for example. On a further note, the terminal devices 110, 120, 130 may comprise V2X devices which may provide communication capability to vehicles, for example. V2X device may be communicatively coupled with a vehicle system, and thus may have access to vehicle data. As a general note, terminal devices 110, 120, 130 may be used to provide communication capability for a vehicle, passenger or for a pedestrian, for example. Thus, terminal devices 110, 120, 130 may be used, at least in some embodiments, for providing access to both V2X communication services and other communication services (e.g. voice, SMS, Internet). However, some terminal devices may only be capable for V2X communication. Also some terminal devices may only be capable for said other communication services. That is, they may not necessarily be used for V2X communication services. A skilled person will understand how different terminal devices may be utilized in the systems of FIGS. 1A and 1B.

V2X communication may comprise Vehicle-to-Vehicle (V2V) communication, Vehicle-to-Pedestrian (V2P), and/or Vehicle-to-Infrastructure/Network (V21/N/N). V2V may comprise LTE-based communication between vehicles. V2P may comprise communication between a vehicle and a device carried by an individual (e.g. handheld terminal carried by a pedestrian, cyclist, driver or passenger). V21/N/N may comprise communication between a vehicle and a roadside unit/network. A roadside unit (RSU) (e.g. ITS-S roadside unit 154) is a transportation infrastructure entity (e.g. an entity transmitting speed notifications) implemented in a network element or a terminal device. For example, LTE and/or 5G system may comprise capability or provide capability for said V2X communication. However, V2X may not be limited to these examples.

Using a LTE-based communication as an example, a V2X data packet may be sent via the interface between the UE and the eNB (Uu interface) or via the interface between the UEs or between the UE and the UE-to-Network Relay (PC5 interface). Spectrum usage options for LTE-based V2X may comprise using a dedicated spectrum or a shared spectrum. For example, a spectrum on which V2X Service can be provided may be designated for use only by V2X devices and services. Using a shared spectrum may mean that spectrum is shared with V2X services and some other LTE communication services. For example, the dedicated V2X carrier may be in 5 GHz band (V2X band), or 2 GHz band (LTE band). In short, the radio communication system of FIG. 1A may, for example, enable using 5 GHz, 2 GHz bands, or any other bands assigned by regulators.

In some embodiments, the radio communication system of FIGS. 1A and 1B may comprise an Intelligent Transportation System (ITS) communication system. Therefore, it may be understood that the described radio communication system may comprise a cellular communication system (e.g. LTE, 5G) and the ITS communication system. However, it may not be necessary that these systems are separate, and may thus be integrated into one system having the functions which are suitable for each use case. To further explain the situation, the network element 102 may, for example, provide a cellular service for one or more terminal devices. Further, it may act as (or comprise) a central unit or provide V2X service for V2V communication system.

It needs to be noted that although the terminal devices 110, 120, 130 are introduced as a group, it may be possible that there is only one terminal device 110 in the cell. That is, it is not necessary for the system that there is a plurality of terminal devices. On the other hand, the system introduced in FIG. 1A may support plurality of terminal devices. The terminal devices 110, 120, 130 may comprise, for example, cell phones, smart phones, tablets, and/or vehicles (i.e. vehicle terminal devices), for example. In an embodiment, the radio communication system of FIGS. 1A to 1B supports PCS based communication. This may mean that the terminal devices 110, 120, 130 may be able to directly communicate with each other. Therefore, for example, V2V communication may be possible directly between two V2X terminal devices.

The radio communication system of FIGS. 1A to 1B may support Carrier Aggregation (CA). CA may enable increasing usable bandwidth between the terminal devices and network elements of the radio communication system.

For example, in the 3GPP, CA may be used for LTE-A in order to support wider transmission bandwidths enhancing increased potential peak data rates to meet LTE-A requirements. For example, more than one component carriers may be aggregated contiguously and/or non-contiguously to provide a wider bandwidth. In uplink carrier aggregation, multiple uplink component carriers may be aggregated and can be allocated in a subframe to a terminal device. Further, the radio communication system may support intra-band CA with contiguous and/or non-contiguous resource allocation. The radio communication system may also support inter-band CA enabling non-contiguous resource allocation from more than one radio band.

The radio communication system of FIGS. 1A to 1B may support Dual Connectivity (DC). Naturally, in order to use DC, the at least one terminal device 110, 120, 130 may also need to support DC. The DC may be a radio communication system feature, wherein the at least one terminal device 110, 120, 130 may simultaneously receive from and/or may simultaneously transmit to at least two network points. Similarly, the radio communication system of FIGS. 1A to 1B may support Multiple-Input and Multiple-Output (MIMO). Thus, the network elements and/or the terminal devices of the radio communication system may comprise more than one antenna for data transfer.

For example, the network element 102 may be a primary network element (e.g. Primary eNB) providing a Primary Cell (PCell) and the network element 112 may be a secondary network element (e.g. Secondary eNB) providing a Secondary Cell (SCell).

It may be possible that the radio communication system shown in FIGS. 1A to 1B supports Licensed-Assisted Access (LAA) which relates to using unlicensed radio band(s) for data transfer. For example, the network element 102 and/or the second network element may provide one or more unlicensed cells in order to increase data transfer capability on the radio communication system. For example, the network element 102 may allocate radio resources of the one or more unlicensed cell for the at least one terminal device 110, 120 through CA, thus increasing the data transfer between the at least one terminal device 110, 120 and the network element(s).

Referring to FIG. 1A, the terminal devices 110, 120, 130 may communicate with the network element 102 and/or with the network element 112. The communication may be unidirectional and/or bidirectional, for example. That is, the network element 102 may, for example, broadcast data within the cell 104 (e.g. the whole cell or a subpart of the cell). The broadcasted data may be detected and received by the terminal devices 110, 120, 130. Similarly, the system may support unicast. That is, for example, the terminal devices 110, 120, 130 may be in communication with the network element 102 using a bidirectional communication. In some embodiments, said system supports multicast.

A further aspect, which may be beneficial to be brought out in even clearer terms is that the radio communication system of FIGS. 1A and 1B may comprise one or more radio communication networks. This may mean that there may be a plurality of communication networks in the system. For instance, there may be two or more service providers that provide networks in said system.

Thus, for example, an MME may indicate its supported Public Land Mobile Network (PLMN) ID to the network element 102 using a message. The network element 102 may be preconfigured with one or more PLMN IDs especially in the case that it is shared between two operators or service providers. So what should be further noted is that the complexity of the present and future communication systems and networks related to V2X communication may be quite high. Also, it is possible that limitations of current systems may need to be solved in order to provide adequate support for V2X communications. For example, in the present LTE-based systems it may not be possible to utilize a specific carrier(s) or spectrum for V2X communication services. That is, it may not be possible to use specific V2X carriers for V2X communication and use LTE carriers for other LTE communication. This may be as during the Evolved Radio

Access Bearer (E-RAB) establishment procedure, the eNB may not know whether the requested E-RAB is to be used for V2X service. For example, the following use cases may not be supported.

Scenario 1: An eNB has a cell #1 using LTE carrier for LTE service, and cell #2 using V2X carrier for V2X service. For example, if UE (i.e. terminal device) connects to cell #1 for LTE service, and connects to cell #2 only for V2X service. If both cells have same or overlapping coverage, there is no guarantee that eNB configures radio resources from cell #2 only for V2X service.

In scenario 2, only operator A has eNBs in a specific area. Operator A may own the V2X spectrum. An eNB has cell #1 using LTE carrier for LTE service, and cell #2 using V2X carrier for V2X service. Operator B's UE connects to the cell #2 only for V2X service. It may not be guaranteed that cell #2 only provides V2X service to operator B's UE.

Similarly, in scenario 3, both operator A and operator B may deploy eNBs in a specific area. Operator A may own the V2X spectrum. Operator A′s eNB provides cell #1 using LTE carrier for LTE service, and cell #2 using V2X carrier for V2X service. Operator B's UE may connect to operator B's eNB for LTE service, and connect to A's eNB (i.e. cell #2) only for V2X service. Similarly, it cannot be guaranteed that cell #2 only provides V2X service to operator B's UE.

It is apparent, but still highlighted, that these three scenarios described above need to be understood as examples of different use cases. Also, solutions described herein are not limited only to LTE-based systems as the problems rising from different systems may be similar and/or the same. Therefore, there is provided a solution to enhance radio bearer establishment. The solution may be particularly beneficial for V2X communication services, but may also enhance usage of other communication services.

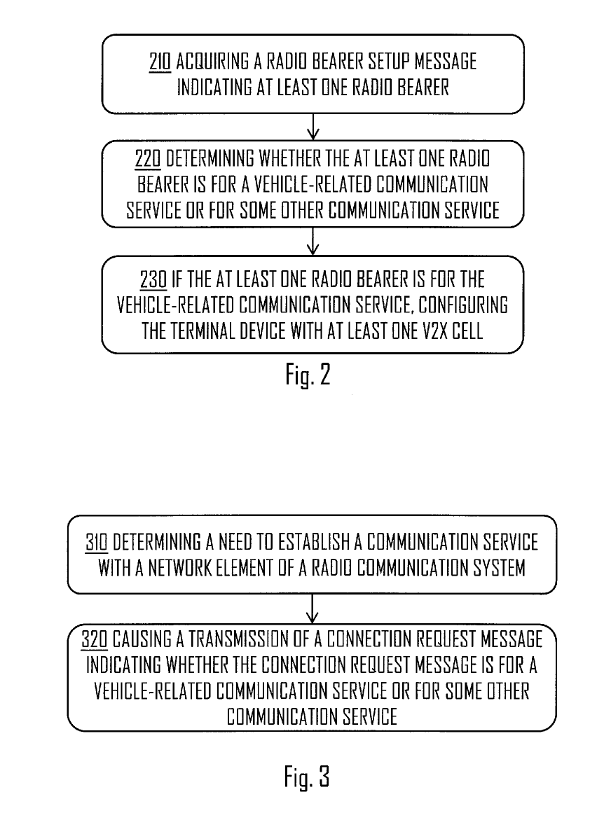

FIG. 2 illustrates a flow diagram according to an embodiment. Referring to FIG. 2, a first network element of a radio communication system may acquire a radio bearer setup message from a second network element of the radio communication system, the radio bearer setup message indicating at least one radio bearer to be used by a terminal device of the radio communication system for at least one communication service (step 210). The first network element may determine, based on the radio bearer setup message, whether the at least one radio bearer is for a vehicle-related communication service or for some other communication service (step 220). As a response to determining that the at least one radio bearer is for the vehicle-related communication service, the first network element may configure the terminal device with at least one V2X cell configured to provide radio resources for the vehicle-related communication service (step 230). At least in some embodiments, the at least one V2X cell may be any radio cell that is configured to provide radio resources for the vehicle-related communication service. The first network element performing the steps of FIG. 2 may be, for example, the network element 102 or one or more circuitries comprised in the network element 102. Therefore, for example, said first network element may be a base station or eNB. In some embodiments, the first network element is referred to as a network node. The second network element described in relation to FIG. 2 may be an MME or comprised in an MME, for example.

FIG. 3 illustrates a flow diagram according to an embodiment. Referring to FIG. 3, a terminal device may determine a need to establish a communication service with a network element of a radio communication system (step 310). The terminal device may cause a transmission of a connection request message to the radio communication system, the connection request message indicating the need to establish the communication service, wherein the connection request message further indicates whether the connection request message is for a vehicle-related communication service or for some other communication service (step 320).

The terminal device performing the steps of FIG. 3 may be one of the terminal devices 110, 120, 130, for example. Said terminal device may be V2X terminal device, for example. The network element described in relation to FIG. 3 may be the network element 102 or another terminal device, for example. It needs to be understood that the communication service may be established via network element 102 although the target device would be another V2X terminal device. On the other hand, it may be possible that the communication service is established with some other element of the radio communication system, such as the network element 102 and/or network element 112. The connection request message may be transmitted to one or more network elements of the radio communication network. Describing one example, the terminal device 110 may determine a need to establish a V2V communication service (e.g. with another terminal device directly or via some network element). The terminal device may transmit the connection request accordingly to the network element 102, for example.

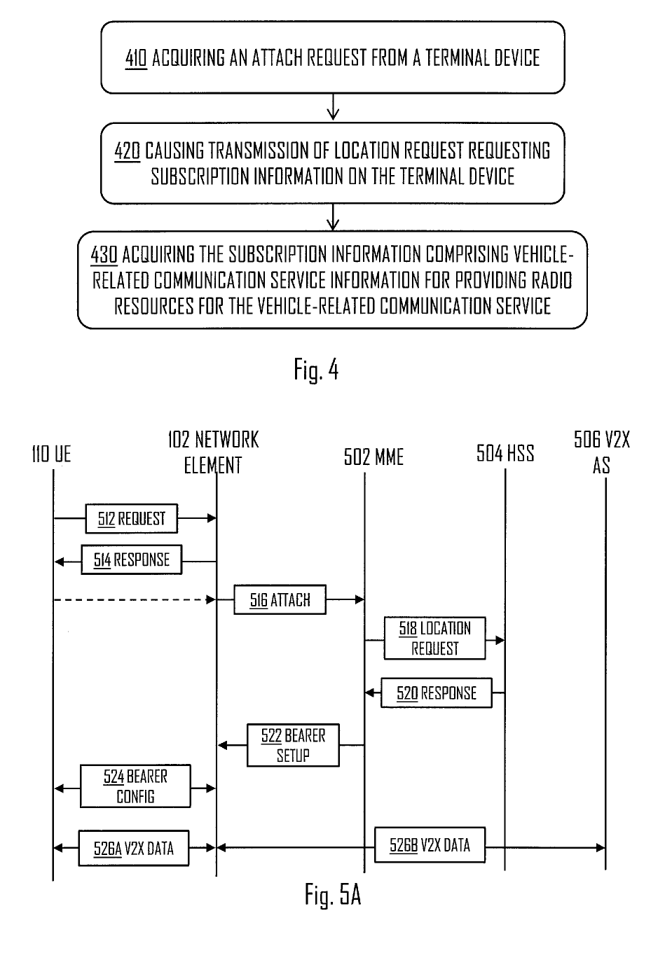

FIG. 4 illustrates a flow diagram according to an embodiment. Referring to FIG. 4, a first network element of a radio communication system may acquire an attach request from a terminal device of the radio communication system (step 410). The first network element may, after the receiving the attach request, cause a transmission of a location request message to a second network element of the radio communication system, the request message requesting subscription information on the terminal device (step 420). As a response to the transmission of the location request message, the first network element may acquire the subscription information on the terminal device from the second network element, wherein the subscription information comprises vehicle-related communication service information for providing radio resources for the vehicle-related communication service (step 430).

The first network element performing the steps of FIG. 4 may be or be comprised in an MME. In some embodiments, said first network element may comprise the MME. The second network element described in relation to FIG. 4 may be or be comprised in a Home Subscriber Server (HSS), for example. In some embodiments, the MME and the HSS are comprised in the same network element. That is, said first and second network elements may be comprised in same physical entity, for example. However, in some embodiments, they may be comprised in different physical entities.

In an embodiment, the first network element performing the steps of FIG. 4, may, after step 430 of FIG. 4, transmit a radio bearer setup message to a third network element (e.g. eNB or similar) of the radio communication system, wherein the radio bearer setup message indicates at least one radio bearer to be established and/or used for the vehicle-related communication service. This embodiment may be discussed in more detail with respect to FIGS. 5A to 5B. However, the radio bearer setup message may cause the third network element to cause allocating of radio resources for a terminal device for the V2X communication service (e.g. configure the terminal device with one or more V2X cells).

Let us now look in detail on some of the operations performed by different entities which themselves, at least in part, enable the benefits described above. Let us first refer again to FIG. 1A, wherein the core network 190 may comprise the MME and/or HSS. The core network 190 may also comprise other elements, such as Service Gateway (S-GW), PDN Gateway (P-GW), and V2X Application Server (AS). When the Uu interface is used, the V2X traffic initiated by the terminal device may be routed to S-GW/P-GW, which is further sent to the V2X AS. The V2X AS may distribute the V2X traffic to other terminal devices. The V2X AS may also generate the V2X traffic, e.g. warning message and the like.

Further, as it was shortly discussed above, the terminal devices 110, 120, 130 may comprise both smart phones, tablets, and the like, as well as V2X terminal devices. For example, if V2X UE 120 determines a need for V2X communication service, the V2X UE 120 may indicate this to the network element 102. The connection request message may indicate that the request is for V2X communication service. Thus, the network element 102 may so decide whether to accept the connection request. If acceptable, the network element 102 may configure the V2X UE 120 with a cell that is capable of providing resources for the V2X communication service. In another example, the UE 130 may transmit a connection request message indicating a need for some other is communication service. Therefore, the network element 102 may then configure the UE 130 with a cell that provides radio resources for said other communication service. Thus, the indication about the service type may give a benefit of using appropriate radio resources for the required service.

FIGS. 5A to 5B illustrate signal diagrams according to some embodiments. The signal diagram may show actions performed by a plurality of different devices of the radio system. Let us first consider Figure SA on the terminal device side. Referring to FIG. 5A, as described above, the terminal device 110 (or UE 110) may transmit a connection request message to a network element of the radio communication system (block 512). For example, the connection request message may be transmitted to the network element 102. The terminal device 110 may, for example, be situated in one or more cells provided by the network element 102. The connection request message may indicate, to the network element 102, whether the connection request message is for a V2X communication service or for some other communication service (e.g. normal LTE connection).

In an embodiment, the radio connection request message is a Radio Resource Control (RRC) connection request message.

In an embodiment, the connection request message comprises a specific field for indicating whether the connection request is for the V2X communication service or for said some other communication service. For example, the specific field may comprise one or more bits or bytes for indicating the cause.

In an embodiment, referring to FIG. 5A, acquiring a connection request message from the terminal device by a network element (e.g. the network element 102), the connection request message indicating a need, by the terminal device, to establish a communication service with a network element of the radio communication system, wherein the connection request message further indicates whether the connection request message is for the vehicle-related communication service or for said some other communication service; and accepting the connection request, if the connection request message indicates that the connection request message is for the vehicle-related communication service, otherwise declining the connection request.

In an embodiment with reference to FIG. 5A, the terminal device 110 acquires, as a response to transmitting the connection request message, a connection response message indicating whether or not the connection request is accepted (block 514).

In an embodiment, the connection response message is a RRC connection setup message.

In an embodiment, the terminal device 110 keeps transmitting the connection request message until a response is received.

In an embodiment, the connection response message indicates that the connection request is accepted if the connection request message requests connection for the V2X communication service. The connection response message may indicate that the connection request is declined if the connection request message requests connection for said some other communication service (i.e. not for V2X service). Declining may happen, for example, if the connection request message is transmitted to a network element that is only for V2X services. For example, if the terminal device 110 is in a V2X cell, it may request radio resources for some other communication service (e.g. voice call). However, as the V2X cell is not capable of providing such resources, the request may be declined by the network element providing said cell. In another example, a normal LTE device (e.g. non-V2X UE) transmits a connection request (e.g. RRC connection request) to a V2X cell, the V2X cell (or the controller of that cell) may reject the request.

Still referring to FIG. 5A, if the connection request is accepted by the radio communication network (e.g. the network element 102), the connection response may so indicate (block 514). Therefore, in block 516, the terminal device 110 may initiate attach procedure. This may comprise transmitting an attach request to an MME 502 of the radio communication system. The attach request may be transmitted, for example, via the network element 102 or via some other network element that is controlled by the MME 502.

The MME 502 may receive the attach request (block 516). The MME 502 may send a location update request message (e.g. Update Location Request message) to a HSS 504 (block 518). The 504 may acknowledge the location update request message by sending a location update response message (e.g. Update Location Answer message) to the MME 502 (block 520). Said location update response message may comprise UE's 110 V2X subscription information. For example, the V2X subscription information may comprise a flag indicating whether a specific Access Point Name (APN) is to be used for V2X communication service. Said message may also include the PLMN IDs to be used for V2X service. For example, this may be used when the operator designates a PLMN ID to be used only for V2X communication service. In an embodiment, the UE's 110 V2X subscription information indicates that the UE 110 is allowed to use the V2X communication service. In such case, the MME 502 may, after receiving the response message (block 520), communicate with the radio communication system, wherein the communication comprises at least one message causing the network element 102 to configure at least one cell configured to provide radio resources for the V2X communication service for the V2X communication by the UE 110. One example of this may be seen in FIG. 5A, wherein the MME 502 may communicate with the network element 102 (block 522). The message may indicate the radio bearer to be established for V2X communication service. The MME 502 may also include additional V2X information, e.g. Tracking Area Identifier (TAI) in case operator assigns separate TAIs for V2X eNBs. By using TAI, the eNB may know the candidate Scells or SeNBs for V2X service. The MME may also inform the eNB about the PLMN IDs to be used for V2X service (example of this can be seen in FIG. 5B). The message may also indicate an additional radio bearer to be established for non-V2X communication service.

For example, if network element 102 is configured only to provide the V2X communication services, but the received message from MME 502 (block 522) does not include the V2X information, the network element 102 may reject the bearer setup request message. This may further mean that the network element 102 does not configure the at least one cell for the terminal device 110.

In another example, if the network element 102 is configured only to provide the V2X communication services, and the received message from MME 502 (block 522) indicates a radio bearer to be established for V2X communication service, the network element 102 may configure the at least one cell for the terminal device 110 providing radio resources for the V2X communication service.

In another example, if network element 102 is configured only to provide the V2X communication services, and the received message from MME 502 (block 522) indicates both the radio bearer to be established for V2X communication service, and an additional radio bearer to be established for non-V2X communication service, the network element 102 may configure the at least one cell for the terminal device 110 providing radio resources for the V2X communication service. The network element 102 may reject the requested bearer that is for non-V2X communication service, or the network element 102 may request other non-V2X network element to provide radio resource for the non-V2X communication service, for example.

In an embodiment, the connection request message is for the V2X communication service. In such case, the terminal device 110 may, after receiving the connection response message (block 514), communicate with the radio communication system, wherein the communication comprises acquiring at least one message from the radio communication system, the at least one message causing the terminal device 110 to configure with at least one cell configured to provide radio resources for the V2X communication service.

One example of this may be seen in FIG. 5A, wherein the network element 102 may communicate with the terminal device 110 (block 524). The network element 102 may configure the terminal device 110 with one or more V2X cells provided by the network element 102 or some other network element. For example, dual connectivity may be utilized. For example, if the network element 102 provides one cell for V2X communication and one other cell for some other communication, the network element 102 may configure said one cell for V2X communication with the terminal device 110.

In an embodiment, the at least one message transmitted (block 524) indicates at least one radio bearer for the V2X communication service. Thus, if the terminal device 110 requests radio resources for the V2X communication service, the radio communication system (e.g. the network element 102) may indicate the at least one radio bearer for the V2X communication. Therefore, for example the network element 102 may configure the radio resource of a specific V2X carrier to be used by the terminal device 110.

In blocks 526A and 526B, the terminal device 110 may utilize the V2X communication service via the at least one radio bearer for the V2X communication service. The at least one bearer may be, for example, an E-RAB for the V2X communication service. Therefore, in block 526A and 526B, V2X data may be transmitted between the terminal device 110 and the network element 102. Further, V2X data may be transmitted between the network element 102 and a V2X AS 506. This may mean, for example, that the established at least one radio bearer (e.g. E-RAB) may enable data to transfer first from the terminal device 110 to the network element 102 and from there to the V2X AS 506.

Let us look closer on FIG. 5A from the network element 102 point of view. As it was already briefly discussed, the network element 102 may receive connection request message from the terminal device 110 (block 512). The network element 102 may accept or decline the request based on one or more criterion. For example, if the network element 102 is a V2X network element 102 or the cell that the terminal device is using is a V2X cell (e.g. capable of providing only V2X communication services), the network element 102 may decline or reject the connection request message if the message does not indicate that it is for a V2X communication service. This may prevent a non-V2X terminal device to attach to the V2X network element 102 (e.g. V2X eNB) or a cell of the V2X network element 102 (e.g. V2X cell). Also, if the request is accepted, the response message may be transmitted to the terminal device 110. Further, the attach request (block 516) may be received by the network element 102, and conveyed to the MME 502, for example.

At this point it may be worth to separately mention that the communication of blocks 512-514 may be performed between, for example, one terminal device and one network element (e.g. base station). That is, the connection to the network or to the radio system by the terminal device 110 may happen via a different network element than the actual bearer indication. To be even more specific, for example, the communication of block 524 may be performed between the terminal device 110 (i.e. the same that requests the connection) and some other network element (i.e. not necessarily the network element 102). Thus, for example, a first network element may communicate with the terminal device 110 in blocks 512 and 514, whereas a second network element may communicate with the terminal device 110 in block 524, for example. However, in some embodiments, the same network element (e.g. the network element 102) may perform all these communication steps together with the terminal device 110.

Before looking the steps performed by the MME 502 and the HSS 504, let us discuss further about the radio bearer setup. So as it was described above, the network element 102 may receive a radio bearer setup message from another network element (e.g. the MME 502) (block 522 of FIG. 5A). The radio bearer setup message may indicate at least one radio bearer to be established and/or used by the terminal device 110 for one or more services (e.g. V2X service or some other service). If the radio bearer(s) are for a V2X service for the terminal device 110, the network element 102 may continue on to configure the terminal device 110 with a cell or cells that are capable of providing radio resources for such service.

In some instances, the radio bearer setup message is referred to as initial context setup procedure or E-RAB setup procedure in the case that E-RABs are utilized.

Thus, in block 524, the network element 102 may transmit at least one message to the terminal device 110 that configures the terminal device 110 with one or more cells for the V2X communication service. Block 524 may further comprise communication between the terminal device 110 and the network element 102. In general, however, the communication of block 524 may cause the terminal device 110 to configure with said one or more cells.

The network element 102 may be aware whether or not one or more cells, provided by the network element 102, provide V2X communication service or are capable of providing such service. In some embodiments, the network element 102 may know whether or not its neighboring cells provide V2X communication service. This may happen via pre-configuration or via communication (e.g. X2 interface 180) with other network elements providing said neighbor cell(s). The neighbor cell may refer to a cell that is adjacent to a cell that is provided by the network element 102 or to a cell that is at least partially overlapping with one or more cells provided by the network element 102, for example. For example, cells 104 and cell 114 may be neighboring cells to each other, wherein the first network element 102 provides the cell 104 and the second network element 102 provides the cell 114.

In an embodiment, the configuring the terminal device with at least one cell configured to provide radio resources for the V2X communication service comprises causing, by the network element 102, establishment of at least one radio bearer between the terminal device 110 and at least one other network element, wherein the at least one radio bearer is for the V2X communication service. One example of this may be shown in FIG. 5A, where the bearer setup message received from the MME 502 by the network element 102 comprises indication about the at least one radio bearer. That is, the MME 502 indicates which radio bearer(s) can or should be used for the requested service by the terminal device 110. The network element 102 may communicate with at least the terminal device 110 such that the at least one radio bearer is established. The at least one radio bearer may be established between the network element 102 and the terminal device 110, for example. The at least one radio bearer may be established between some other network element (e.g. the network element 112) and the terminal device 110, for example. The at least one radio bearer may be established between the terminal device 110 and some other terminal device, for example. Further, as discussed above, in the case of E-RAB, the established bearer may comprise a link between the network element 102 (or some other network element) and the core network 190, which support the communication between the terminal device 110 and the V2X AS 506.

In an embodiment, the network element 102 acquires a V2X communication service transmission from the terminal device 110 (block 526A). Said transmission may be transmitted, by the terminal device, via the established at least one radio bearer for the V2X communication service. As was discussed, the at least one established bearer may also comprise a link between the network element 102 and the core network 190, which support the communication between the terminal device 110 and V2X AS 506 (block 526B).

In an embodiment, the at least one cell configured to provide radio resources for the V2X communication service is configured as at least one V2X communication cell providing service only for V2X communication services. Therefore, the radio resources for the V2X communication services may be provided by a cell or cells that are only for the V2X communication services. This may also enable, for example, the network element 102 to allocate radio resources for non-V2X communication services from different cells (i.e. from cells that are not dedicated for V2X services). For example, looking at FIG. 1A, the network element 102 may, at least in some embodiments, control both cells 104, 114. It may be that each of the cells 104, 114 are provided only by the network element 102, or by both the network element 102 and the network element 112, for example. However, cell 114 may be configured as a V2X cell and the cell 104 may be configured as a cell that provides only non-V2X radio resources (e.g. a regular cell). When a V2X terminal device 120 requests the radio resources for the V2X communication, the network element 102 may configure the V2X terminal device 120 with the cell 114. However, if the V2X terminal device 120 requests radio resources for non-V2X communication, the network element 102 may configured said terminal device with the cell 104.

In an embodiment, the radio bearer setup message, transmitted by the MME 502 to the network element 102 in block 522, comprises V2X information associated with the terminal device 110. In an embodiment, the radio bearer setup message or the V2X information comprises a radio bearer-specific field for indicating whether the at least one radio bearer is for the V2X communication service or for some other communication service (i.e. non-V2X communication service). The specific field may comprise, for example, a V2X flag (e.g. bit(s)) for indicating a specific radio bearer(s) (e.g. E-RAB) to be used for the V2X communication service. There may be a radio bearer -specific field for each radio bearer indicated by the radio bearer setup message. For example, if there are two radio bearers indicated, there may be two radio bearer -specific fields in the radio bearer setup message. Thus, for each radio bearer, it may be indicated whether the radio bearer is for the V2X communication.

In an embodiment, the radio bearer setup message indicates two or more radio bearers.

In an embodiment, the radio bearer -specific field indicates whether the at least one radio bearer is for the V2X communication service. So, for example, if there is no such field or indication, the radio bearer may be for non-V2X communication service.

In some embodiments, the V2X information or the radio bearer setup message comprises one or more V2X PLMN IDs and/or one or more V2X Tracking Area Identifiers (TAIs).

The V2X PLMN ID(s) may each indicate a radio communication network for providing the V2X communication service. Thus, the MME 502 may indicate to the network element 102 which radio network should be used to provide the radio resources to the terminal device 110 for the V2X communication. Thus, the at least one cell configured, by the network element 102, to provide radio resources for the V2X communication service is comprised in said indicated radio communication network. For example, if two PLMN IDs are indicated, the network element 102 may select one and utilize that network. However, it is possible that only one PLMN ID is indicated, and thus there may not be options for the network element 102.

In an embodiment, the radio bearer setup message comprises at least one network identifier (e.g. PLMN ID), wherein each network identifier indicates a radio communication network for providing the vehicle-related communication service, and wherein the at least one cell configured to provide radio resources for the vehicle-related communication service is comprised in said indicated radio communication network.

In an embodiment, the radio bearer setup message, transmitted by the MME 502 to the network element 102 in block 522, comprises a tracking area identifier (TAI) or TAIs. For example, the operator designates some TAIs only for V2X service. The network element 102 can use the received TAIs to select the candidate cells to serve the UE 110. For example, the network element 102 may select the at least one V2X cell based at least partly on the indicated TAIs.

In an embodiment, as a response to determining, based on the radio bearer setup message transmitted by the MME 502 to the network element 102 in block 522, that the at least one radio bearer is for said some other communication service (e.g. non-V2X communication service), performing, by the network element 102, an action based at least on characteristics of the terminal device 110. There are at least two ways to become aware, by the network element 102 about the characteristics of the terminal device 110. Firstly, the radio bearer setup message may comprise indication whether or not the terminal device 110 is a V2X UE or a non-V2X UE (e.g. the V2X information). Secondly, if the same network element 102 acts also the receiver of the connection request (block 512), the network element 102 may already know which kind of UE the terminal device 110 is (request of block 512). In an embodiment, the performing the action based at least on characteristics of the terminal device 110 comprises rejecting, by the network element 102, the radio bearer setup message if the terminal device 110 is a vehicle terminal device (i.e. V2X UE). Otherwise the network element 102 may configure the terminal device 110 with at least one cell configured to provide radio resources for said some other communication service.

In an embodiment, the network element 102 rejects the radio bearer setup message transmitted by the MME 502 if the all radio bearers indicated by the radio bearer setup message are for non-V2X communication service(s). In some embodiments, the rejecting may, at least in some embodiments, further require that the terminal device 110 is a V2X UE. All radio bearers may mean one or more radio bearers that are indicated by said message.

In an embodiment, as a response to determining by the network element 102, based on the radio bearer setup message transmitted by the MME 502 to the network element 102 (block 522), that the at least one radio bearer is for the V2X communication service, performing, by the network element 102, an action based at least on characteristics of the terminal device 110. So the network element 102 may first determine whether or not the terminal device 110 is a V2X UE or a non-V2X UE, for example. As explained above, the network element 102 may determine this, for example, during the RRC connection establishment procedure. Then the network element 102 may determine that the radio bearer setup message is associated with or related to V2X communication service. Then, the action may be performed which may depend on the characteristics of the terminal device 110. In an embodiment, the performing the action based at least on characteristics of the terminal device 110 comprises rejecting, by the network element 102, the radio bearer setup message if the terminal device 110 is a vehicle terminal device (i.e. V2X UE) and requests a non-V2X communication service (e.g. by transmitting the RRC connection request to the network element 102). Otherwise the network element 102 may configure the terminal device 110 with the at least one cell configured to provide radio resources for V2X communication service (as was explained also with respect to FIG. 2, for example). So in the case that the radio bearer setup message is not associated with V2X communication service and the terminal device 110 is a V2X terminal device, the network element 102 may reject the radio bearer setup message, and thus not cause providing radio resources for the terminal device 110 for the V2X communication service. In some embodiments, if the terminal device 110 is a non-V2X terminal device, the network element 102 may also in that case reject the radio bearer setup message, if the radio bearer setup message is associated with V2X communication service.

In an embodiment, the radio bearer setup message indicates two or more radio bearers. The two or more radio bearers may be for V2X and/or non-V2X communication services. The network element 102 may decline or reject the radio bearer setup message if each of the radio bearers are for non-V2X communication service. In an embodiment, the network element 102 may decline or reject the radio bearer setup message if each of the radio bearers are for non-V2X communication service and the terminal device 110 is a V2X UE. As explained, the radio bearer setup message may comprise radio bearer -specific fields for indicating whether a specific radio bearer is for V2X communication service. Thus, in some embodiments, the V2X UE may utilize radio bearers for both V2X and non-V2X communication services.

In some embodiments, the network element 102 may indicate the rejection of the radio bearer setup message to the MME 502. Thus, the MME 502 may, for example, request another network element to provide the radio resources for a particular UE.

Further, one aspect of the type of the terminal device 110, according to some embodiments, may be that the type may be determined based on the communication service that is requested (e.g. by the network element 102). This may mean that if the terminal device 110 transmits request for V2X communication service, it may be a V2X UE for that particular session or communication service. Vice versa, if non-V2X communication service is requested, the terminal device 110 may be a non-V2X UE. In such case, the network element 102 may accordingly provide radio resources for non-V2X communication services from a non-V2X cell. In the case of V2X communication services, the network element 102 may accordingly provide radio resources from a V2X cell.

In the case of a V2X network element (e.g. V2X eNB), the V2X network element may only accept connection requests from V2X UEs. In the case of a network element that may provide services for non-V2X and V2X communication, connection requests from both V2X UEs and non-V2X UEs may be accepted. Also, the network element 102 may decline or reject the radio bearer setup message if there is no indication, in said message, about V2X communication service. In an embodiment, the network element 102 rejects the radio bearer setup message if the radio bearer setup message is for a non-V2X communication service and the terminal device 110 is a V2X UE.

Let us further discuss the configuring the terminal device 110 with a V2X cell. As discussed the V2X cell may be specifically configured (e.g. by the network element 102) for providing radio resources for the V2X communication service. This may mean that, for example, the cell provides V2X communication resources on a 5 GHz band. The establishment of the at least one radio bearer for the V2X communication service may comprise using a dedicated V2X carrier. Therefore, the bearer configuration (block 524) may comprise indicating the V2X carrier to the terminal device 110. Therefore, in some embodiments, the network element 102 may configure at least one V2X cell (e.g. cell 104) with the terminal device 110 for the V2X communication service. The network element 102 may indicate the at least one radio bearer (e.g. V2X radio bearer) to the terminal device 110. The at least one radio bearer may be established, and the V2X carrier may be utilized by the terminal device 110 to transmit data to one or more target devices.

Let us then look closer on the operations performed by the MME 502 and HSS 504 or similar network elements (e.g. first and second network elements as was discussed in relation to FIG. 4). Referring still to FIG. 5A as an example, the MME 502 may receive an attach request from the terminal device 110 or similar terminal device (block 516). The attach request may be transmitted via another network element, such as the network element 102, to the MME 502. After this, or triggered by the attach procedure, the MME 502 may transmit a location request message to the HSS 504 (block 518). The location request message may indicate the terminal device 110, for example. In more general terms, the location request message may indicate the terminal device to which the location request message is linked to or associated with. The indication may comprise, for example, terminal device identifier. Also, the location request message may be used to request subscription information about the terminal device to which the location request is related to or associated with (e.g. the terminal device 110).

The HSS 504 may receive the location request message (block 518). As a response to the location request message, the HSS 504 may transmit a location response message to the MME 502 (block 520). The HSS 504 may store subscription information about one or more terminal devices in the radio system. Therefore, the HSS 504 may determine to which terminal device the location request message is related to, and thus acquire the subscription information accordingly. The response (block 520) may thus comprise the subscription information on the terminal device 110 in the example of FIG. 5A.

In some embodiments, the subscription information on a terminal device comprises V2X information, such as V2X flag associated with a V2X related Access Point Name (APN), and/or dedicated one or more V2X PLMN IDs. Therefore, for example, the MME 502 may know which radio communication network(s) (e.g. PLMN) may be used. This may help and/or enable the MME 502 in the bearer establishment procedure, which is explained further with respect to block 522 of FIG. 5A, for example. This may be applicable, for example, to a scenario where an operator designates a specific PLMN ID only for V2X service. By transmitting, by the HSS 504, the V2X information to the MME 502, the radio communication system may prevent terminal devices to establish a non-V2X communication service with a V2X cell.

Still referring to FIG. 5A, the MME 502 may thus receive the location response message from the HSS 504 (block 520). After this, the MME 502 may transmit a bearer setup message to the network element 102 (block 522). This may enable the network element 102 to configure (e.g. block 524) the terminal device 110 with a V2X cell (e.g. provided by the network element 102 or some other network element). The V2X cell may be used to provide radio resources for the terminal device 110 so that the terminal device 110 may, for example, utilize a specific V2X carrier on at least one V2X radio bearer (e.g. blocks 526A, 526B).

In more general terms, the MME 502 may transmit a radio bearer setup message to a network element of the radio communication system (e.g. the network element 102 or some other network element), wherein the radio bearer setup message indicates at least one radio bearer to be established for the V2X communication service. Said V2X communication service may be requested or requested to be used by the terminal device 110, for example.

FIG. 5B illustrates a signal diagram according to some embodiments. Referring to FIG. 5B, the terminal device 110 may perform the connection request and attachment procedure as was discussed in relation to FIG. 5B, for example. For example, the connection request (e.g. RRC connection request) may be transmitted to the first network element 102 or to the second network element 112.

So the terminal device 110 may transmit an attach request to the MME 502 (block 516). The MME 502 may acquire or receive the attach request. The MME 502 may then transmit a location request message to the HSS 504 (block 518) and receive the location response request from the HSS 504 (block 520). This may enable the MME 502 to receive the V2X related information regarding the terminal device 110 from the HSS 504. In some embodiments, the actions performed in blocks 516, 518, 520 are comprised in the attachment procedure.

Referring to FIG. 5B, the terminal device 110 may request a service connection from the MME 502 (block 532). For example, a connection request message may be used for the request. The terminal device 110 may request a V2X connection (e.g. for a V2X communication service). In an embodiment, the connection request indicates whether or not the request is for a V2X connection or for a non-V2X connection. In an embodiment, the request is for a V2X Packet Data Network (PDN) connection. The MME 502 may receive the connection request.

In block 534, the MME 534 may transmit a bearer setup message to a first network element 102. The bearer setup message may indicate at least one radio bearer (e.g. E-RAB) to be established for a V2X communication service. The MME 502 may also inform the first network element 102 about a TAI and/or PLMN IDs to be used for V2X service.

The first network element 102, after receiving the bearer setup message indicating the at least one radio bearer for the V2X communication service, may determine or select a cell that is suitable to provide the V2X radio resources. The determination may be based on said V2X information (e.g. a V2X flag, V2X PLMN ID, V2X TAI) received in the bearer setup message from the MME 502. The first network element 102 may know whether a cell provides V2X communication service based on configuration, or via the message exchange with another network element, for example, network element 112. For example, the first network element 102 may configure the terminal device 110 to utilize DC mode, such that the first network element 102 configures a V2X cell from a second network element 112 to the V2X communication (e.g. block 536). Similarly, in some embodiments, the first network element 102 may configure the terminal device 110 to utilize carrier aggregation, such that one cell provides PCell functionality and another cell provides SCell functionality. For example, the PCell may be a non-V2X cell and the SCell may be a V2X cell, or vice versa.

For example, if the second network element 112 provides a V2X cell, the first network element 102 may know this by configuration or by communicating with the second network element 112 (e.g. via X2 interface). Thus, after receiving the bearer setup message (block 534), the first network element 102 may configure the V2X cell of the second network element 112 with the terminal device 110 (blocks 536, 538). The configuring of the V2X cell of the second network element 112 may comprise indicating, by the first network element 102 to the second network element 112, at least one radio bearer (e.g. E-RAB) to be established for a V2X communication service,

In an embodiment, the first network element 102 configures the terminal device 110 to use V2X carrier on radio resources from a V2X cell provided by the second network element 112(block 538). Thus, the terminal device 110 may transmit data to or from the second network element 112, for example. Also, data may be transmitted to or from the V2X AS 506, as was discussed in relation to Figure SA.

In an embodiment, the first network element 102 is a master network element (e.g. MeNB) and the second network element 112 is a secondary network element (e.g. SeNB). In an embodiment, the secondary network element is configured only for V2X communication. That is, resources provided by the secondary network element may only be used for V2X communication services. Thus, for example, in carrier aggregation MeNB may provide radio resources for LTE communication and the SeNB may provide radio resources for the V2X communication. This may be configured by the MeNB or some other network element, for example.

In another embodiment, the MeNB provides resources for V2X service, and the SeNB provides resources for non-V2X service.

In an embodiment, the at least one cell configured to provide the radio resources for the V2X communication service is provided by another network element of the radio communication system. For example, referring to FIG. 5B, the first network element 102 may receive the bearer setup message from the MME 502 (block 536). The first network element 102 may request said another network element to allocate radio resources for the V2X communication service. For example, in block 536, the first network element 102 may send the request to the second network element 112 in which the first network element 102 request that the second network element 112 allocates radio resources for the terminal device 110 from one or more cells provided by the second network element. This may comprise, for example, determining, by the first network element 102 said another network element (e.g. the second network element 112) based on the received V2X information (e.g. received in block 534). The request sent to the second network element 112 may indicate at least one radio bearer (e.g. E-RAB) to be established for a V2X communication service. Further, the request for the allocation of radio resources may be sent to the said another network element.

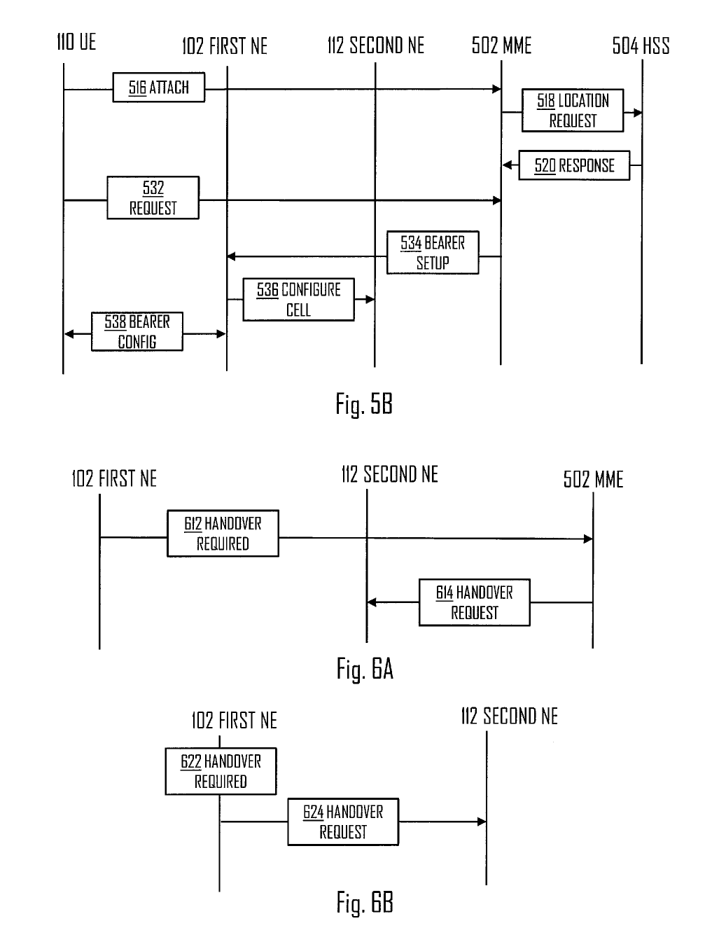

FIGS. 6A to 6B illustrate some embodiments. Referring to FIGS. 6A to 6B, according to an aspect there is provided method comprising: determining, by a network element (e.g. the first network element 102) a handover event associated with a terminal device 110; including vehicle-related communication service information associated with the terminal device 110 to a handover request, wherein the vehicle-related communication service information comprises at least indication about the at least one radio bearer that is to be used for the vehicle-related communication service; and causing a transmission of the handover request to a target network element of the radio communication system. The target network element may, for example, be the second network element 112. Also it may be possible that the handover event is determined by the MME 502, and the request may be transmitted by the MME 502 to another network element.

Referring to FIG. 6A, the first network element 102 may indicate, to the MME 502, that a handover of the terminal device 110 is required (block 612). The MME 502 may transmit a handover request to the second network element 112 that may be the target network element of the handover event (block 614). The handover request (block 614) and/or the indication that the handover is required (block 612) may be transmitted via S1 interface, for example. The first network element 102 may determine and/or select the second network element 112 based on the previously stored V2X information, for example, the PLMN ID, or the TAI, etc, received in block 522 of FIG. 5A or in block 534 of FIG. 5B, for example.

Referring to FIG. 6B, the first network element 102 may determine that a handover of the terminal device 110 is required (block 622). In block 624, the first network element 102 may transmit a handover request to the second network element 112 (i.e. the target network element). The handover request may include vehicle-related communication service information associated with the terminal device 110, wherein the vehicle-related communication service information comprises at least indication about the at least one radio bearer that is to be used for the vehicle-related communication service. The handover request may be transmitted via X2 interface, for example. The first network element 102 may determine and/or select the second network element 112 based on the previously stored V2X information, for example, the PLMN ID, or the TAI, etc, received in block 522 of FIG. 5A or in block 534 of FIG. 5B, for example.

Referring to FIGS. 6A to 6B, the handover request may comprise V2X information on the terminal device 110, e.g. V2X information on the terminal device to which the handover is related to. The V2X information may comprise, for example, an indicator (e.g. a flag) indicating at least one radio bearer for V2X communication service, or that the indicated at least one radio bearer is for the V2X communication service. The V2X information may further comprise V2X PLMN ID if dedicated PLMN ID is used for V2X communication services (e.g. operator may define that a specific PLMN ID is used for V2X communications). Upon the reception of the handover request including the V2X information, the target network element may allocate radio resources from a V2X cell for the terminal device 110.

In an embodiment, referring to FIG. 6A, a first network element (e.g. the MME 502) determines, based on a message from a source network element (e.g. the network element 102), a handover event associated with the terminal device 110 (block 612). The first network element (e.g. the MME 502) may include vehicle-related communication service information associated with the terminal device 110 to a handover request, wherein the vehicle-related communication service information comprises at least indication about the at least one radio bearer that is to be used for the vehicle-related communication service. In block 614, the first network element (e.g. the MME 502) may cause a transmission of the handover request to a target network element (e.g. the network element 112) of the radio communication system. The handover request may comprise other V2X information, as was explained above.

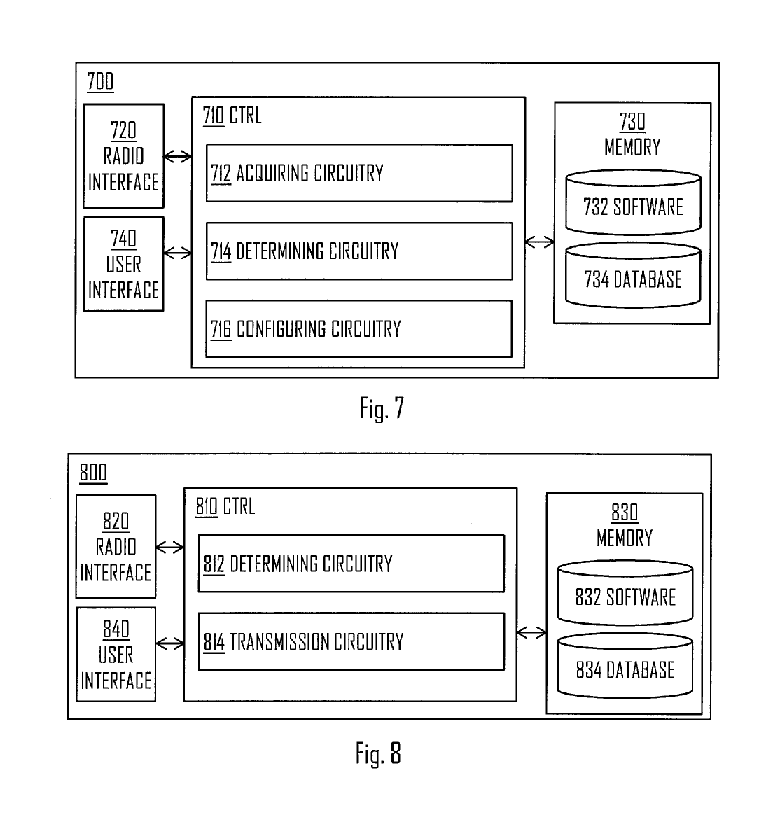

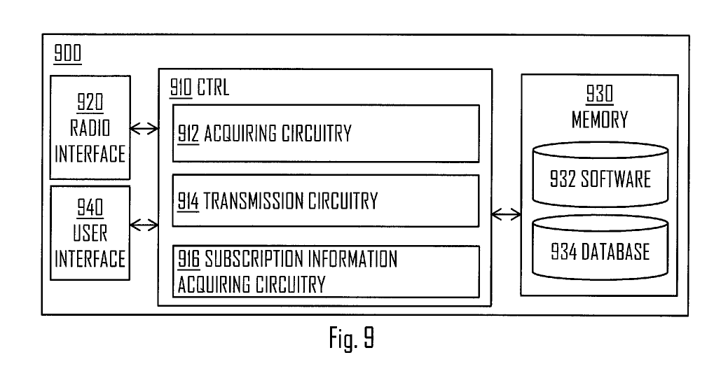

FIGS. 7 to 9 provide apparatuses 700, 800, 900 comprising a control circuitry (CTRL) 710, 810, 910, such as at least one processor, and at least one memory 730, 830, 930 including a computer program code (software) 732, 832, 932, wherein the at least one memory and the computer program code (software) 732, 832, 932, are configured, with the at least one processor, to cause the respective apparatus 700, 800, 900 to carry out any one of the embodiments of FIGS. 1A to 6B, or operations thereof.

Referring to FIGS. 7 to 9, the memory 730, 830, 930, may be implemented using any suitable data storage technology, such as semiconductor based memory devices, flash memory, magnetic memory devices and systems, optical memory devices and systems, fixed memory and removable memory. The memory 730, 830, 930 may comprise a database 734, 834, 934 for storing data.

The apparatuses 700, 800, 900 may further comprise radio interface (TRX) 720, 820, 920 comprising hardware and/or software for realizing communication connectivity according to one or more communication protocols. The TRX may provide the apparatus with communication capabilities to access the radio access network, for example. The TRX may comprise standard well-known components such as an amplifier, filter, frequency-converter, (de)modulator, and encoder/decoder circuitries and one or more antennas. For example, the TRX may comprise a unit for providing cellular communication capabilities (e.g. 3G, 4G, 5G communication) and/or V2X communication capabilities. In an embodiment, said units are separate. In an embodiment, said units are comprised in one entity.

The apparatuses 700, 800, 900 may comprise user interface 740, 840, 940 comprising, for example, at least one keypad, a microphone, a touch display, a display, a speaker, etc. The user interface 740, 840, 940 may be used to control the respective apparatus by a user of the apparatus 700, 800, 900.

In an embodiment, the apparatus 700 may be or be comprised in a base station (also called a base transceiver station, a Node B, a radio network controller, or an evolved Node B, for example). The apparatus 700 may be the network element 102, for example. Further, the apparatus 700 may be the network element performing the steps of FIG. 2. In an embodiment, the apparatus 700 is comprised in the network element 102. For example, the apparatus 700 may cause the network element 102 to perform operations according to any one of the embodiments.

In an embodiment, the apparatus 800 may be or be comprised in a terminal device, such as a vehicle system, vehicle, mobile phone or cellular phone, for example. The apparatus 800 may be the terminal device 110, for example. In an embodiment, the apparatus 800 is comprised in the terminal device 110 or in some other terminal device. For example, the apparatus 800 may cause the terminal device 110 or some other terminal device to perform operations according to any one of the embodiments.

In an embodiment, the apparatus 900 may be or be comprised in a MME 502, for example. In an embodiment, the apparatus 900 is or is comprised in the first network element performing the steps of FIG. 4.

In an embodiment, the apparatus 700 comprises a control circuitry 710 (CTRL) comprising an acquiring circuitry 712 configured to acquire a radio bearer setup message from a second network element of the radio communication system, the radio bearer setup message indicating at least one radio bearer to be used by a terminal device of the radio communication system for at least one communication service; a determining circuitry 714 configured to determine, based on the radio bearer setup message, whether the at least one radio bearer is for a vehicle-related communication service or for some other communication service; and a configuring circuitry 716 configured to, as a response to determining that the at least one radio bearer is for the vehicle-related communication service, configure the terminal device with at least one cell configured to provide radio resources for the vehicle-related communication service.

In an embodiment, the apparatus 800 comprises a control circuitry 810 (CTRL) comprising a determining circuitry 812 configured to determine a need to establish a communication service with a network element of a radio communication system; and a transmission circuitry 814 configured to cause a transmission of a connection request message to the radio communication system, the connection request message indicating the need to establish the communication service, wherein the connection request message further indicates whether the connection request message is for a vehicle-related communication service or for some other communication service.

In an embodiment, the apparatus 900 comprises a control circuitry 910 (CTRL) comprising an acquiring circuitry 912 configured to acquire an attach request from a terminal device of the radio communication system; a transmission circuitry 914 configured to after the acquiring the attach request, cause a transmission of a location request message to a second network element of the radio communication system, the request message requesting subscription information on the terminal device; and a subscription information acquiring circuitry 916 configured to, as a response to the transmission of the location request message, acquire the subscription information on the terminal device from the second network element, wherein the subscription information comprises vehicle-related communication service information for providing radio resources for the vehicle-related communication service.

In an embodiment of FIG. 7, at least some of the functionalities of the apparatus 700 (e.g. the network element 102) may be shared between two physically separate devices, forming one operational entity. Therefore, the apparatus may be considered to depict the operational entity comprising one or more physically separate devices for executing at least some of the above-described processes. Thus, the apparatus of FIG. 7, utilizing such a shared architecture, may comprise a remote control unit (RCU), such as a host computer or a server computer, operatively coupled (e.g. via a wireless or wired network) to a remote radio head (RRH) located at a base station site. In an embodiment, at least some of the described processes of the network element 102 may be performed by the RCU. In an embodiment, the execution of at least some of the described processes may be shared among the RRH and the RCU. In such a context, the RCU may comprise the components illustrated in FIG. 7, and the radio interface 720 may provide the RCU with the connection to the RRH. The RRH may then comprise radio frequency signal processing circuitries and antennas, for example.

In an embodiment, the RCU may generate a virtual network through which the RCU communicates with the RRH. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

Similarly, in some embodiments, functionalities performed by the apparatus 900 may be shared between two physically separate devices, forming one operational entity. In some embodiments, apparatuses 700 and 900 may be comprised in one physical entity. For example, first network element 102, second network element 112, MME 502, HSS 504 and/or the V2X AS 506 may be comprised in same physical entity. In some embodiments, each may be comprised in a separate physical entity.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 1A to 6B may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 1A to 6B or operations thereof.

According to yet another embodiment, the apparatus carrying out the embodiments comprises a circuitry including at least one processor and at least one memory including computer program code. When activated, the circuitry causes the apparatus to perform at least some of the functionalities according to any one of the embodiments of FIGS. 1A to 6B, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 1A to 6B may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1.-20. (canceled)

21. An apparatus comprising:
at least one processor, and
at least one memory comprising a computer program code, wherein the at least one memory and the computer program code are configured, with the at least one processor, to cause a first network element of a radio communication system to perform operations comprising:
acquiring a radio bearer setup message from a second network element of the radio communication system, the radio bearer setup message indicating at least one radio bearer to be used by a terminal device of the radio communication system for at least one communication service;
determining, based on the radio bearer setup message, whether the at least one radio bearer is for a vehicle-related communication service or for some other communication service; and
as a response to determining that the at least one radio bearer is for the vehicle-related communication service, configuring the terminal device with at least one cell configured to provide radio resources for the vehicle-related communication service.

22. The apparatus of claim 21, wherein the configuring the terminal device with at least one cell configured to provide radio resources for the vehicle-related communication service comprises causing, by the first network element, establishment of the at least one radio bearer between the terminal device and at least one other network element, wherein the at least one radio bearer is for the vehicle-related communication service.

23. The apparatus of claim 21, wherein the at least one memory and the computer program code are configured, with the at least one processor, to cause the first network element further to perform operations comprising:
acquiring a connection request message from the terminal device, the connection request message indicating a need, by the terminal device, to establish a communication service with a network element of the radio communication system, wherein the connection request message further indicates whether the connection request message is for the vehicle-related communication service or for said some other communication service; and
accepting the connection request, if the connection request message indicates that the connection request message is for the vehicle-related communication service, otherwise declining the connection request.

24. The apparatus of claim 21, wherein the at least one cell configured to provide radio resources for the vehicle-related communication service is configured as at least one vehicle-related communication cell providing service only for vehicle-related communication services.

25. The apparatus of claim 21, wherein the radio bearer setup message comprises a radio bearer -specific field for indicating whether the at least one radio bearer is for the vehicle-related communication service or for said some other communication service.

26. The apparatus of claim 21, wherein the radio bearer setup message comprises at least one network identifier, wherein each network identifier indicates a radio communication network for providing the vehicle-related communication service, and wherein the at least one cell configured to provide radio resources for the vehicle-related communication service is comprised in said indicated radio communication network.

27. The apparatus of claim 21, wherein the radio bearer setup message comprises at least one tracking area identifier.

28. The apparatus of claim 21, wherein the at least one memory and the computer program code are configured, with the at least one processor, to cause the first network element further to perform operations comprising:
as a response to determining, based on the radio bearer setup message, that the at least one radio bearer is for the vehicle-related communication service, performing an action based at least on characteristics of the terminal device.

29. The apparatus of claim 21, wherein the at least one memory and the computer program code are configured, with the at least one processor, to cause the first network element further to perform operations comprising:
rejecting the radio bearer setup message if the at least one radio bearer is for said some other communication service,
otherwise configuring the terminal device with the at least one cell configured to provide radio resources for the vehicle-related communication service.

30. The apparatus of claim 21, wherein the at least one cell configured to provide the radio resources for the vehicle-related communication service is provided by another network element of the radio communication system, wherein the at least one memory and the computer program code are configured, with the at least one processor, to cause the first network element further to perform operations comprising:
requesting said another network element to allocate radio resources for the vehicle-related communication service.

31. The apparatus of claim 21, wherein the at least one memory and the computer program code are configured, with the at least one processor, to cause the first network element further to perform operations comprising:
determining a handover event associated with the terminal device;
including vehicle-related communication service information associated with the terminal device to a handover request, wherein the vehicle-related communication service information comprises at least indication about the at least one radio bearer that is to be used for the vehicle-related communication service; and
causing a transmission of the handover request to a target network element of the radio communication system.

32. An apparatus comprising:
at least one processor, and
at least one memory comprising a computer program code, wherein the at least one memory and the computer program code are configured, with the at least one processor, to cause a terminal device to perform operations comprising:
determining a need to establish a communication service with a network element of a radio communication system; and
causing a transmission of a connection request message to the radio communication system, the connection request message indicating the need to establish the communication service, wherein the connection request message further indicates whether the connection request message is for a vehicle-related communication service or for some other communication service.

33. The apparatus of claim 32, wherein the connection request message comprises a specific field for indicating whether the connection request is for the vehicle-related communication service or for said some other communication service.

34. The apparatus of claim 32, wherein the at least one memory and the computer program code are configured, with the at least one processor, to cause the terminal device further to perform operations comprising:
as a response to the connection request message, acquiring a connection response message indicating whether or not the connection request is accepted.

35. The apparatus of claim 34, wherein the connection response message indicates that the connection request is accepted if the connection request message requests connection for the vehicle-related communication service,
and wherein the connection response message indicates that the connection request is declined if the connection request message requests connection for said some other communication service.

36. The apparatus of claim 34, wherein the connection request is for the vehicle-related communication service, wherein the at least one memory and the computer program code are configured, with the at least one processor, to cause the terminal device further to perform operations comprising:
after receiving the connection response message, communicating with the radio communication system, wherein the communication comprises acquiring at least one message from the radio communication system, the at least one message causing the terminal device to configure with at least one cell configured to provide radio resources for the vehicle-related communication service.

37. An apparatus comprising:
at least one processor, and
at least one memory comprising a computer program code, wherein the at least one memory and the computer program code are configured, with the at least one processor, to cause a first network element of a radio communication system to perform operations comprising:
acquiring an attach request from a terminal device of the radio communication system; and
after the acquiring the attach request, causing a transmission of a location request message to a second network element of the radio communication system, the request message requesting subscription information on the terminal device; and as a response to the transmission of the location request message, acquiring the subscription information on the terminal device from the second network element, wherein the subscription information comprises vehicle-related communication service information for providing radio resources for the vehicle-related communication service.

38. The apparatus of claim 37, wherein the at least one memory and the computer program code are configured, with the at least one processor, to cause the first network element further to perform operations comprising:
transmitting a radio bearer setup message to a third network element of the radio communication system, wherein the radio bearer setup message indicates at least one radio bearer to be used for the vehicle-related communication service.

39. The apparatus of claim 38, wherein the radio bearer setup message comprises a list one or more network identifiers and/or a list of one or more tracking area identifiers.

40. The apparatus of claim 37, wherein the at least one memory and the computer program code are configured, with the at least one processor, to cause the first network element further to perform operations comprising:
determining, based on a message from a source network element, a handover event associated with the terminal device;
including vehicle-related communication service information associated with the terminal device to a handover request, wherein the vehicle-related communication service information comprises at least indication about the at least one radio bearer that is to be used for the vehicle-related communication service; and
causing a transmission of the handover request to a target network element of the radio communication system.

41.-43. (canceled)
